(19) United States
(12) Patent Application Publication
(10) Pub. No.: US 2026/0099103 A1
(43) Pub. Date: Apr. 9, 2026

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA (JP)

(72) Inventors: KAZUTAKA SUGIMOTO, OSAKA (JP); RYOTA MORIKAWA, OSAKA (JP)

(21) Appl. No.: 19/346,502

(22) Filed: Sep. 30, 2025

(30) Foreign Application Priority Data
Oct. 7, 2024 (JP) 2024-175978

(51) Int. Cl. G03G 5/14; G03G 15/02; G03G 21/18

(52) U.S. Cl. CPC G03G 5/144; G03G 15/0216; G03G 21/1814; G03G 2215/00957; G03G 2215/00962

(57) ABSTRACT

An electrophotographic photoreceptor includes: a conductive base; an intermediate layer provided on the conductive base; and a photosensitive layer provided on the intermediate layer, the intermediate layer including titanium oxide and an intermediate layer resin, the titanium oxide having been subjected to no surface treatment with an inorganic material, a content of the titanium oxide being 1.3 parts by mass or more and 1.7 parts by mass or less with respect to 1.0 part by mass of the intermediate layer resin.

### CROSS-REFERENCE TO RELATED PATENT APPLICATION

This application claims the benefit of Japanese Priority Patent Application JP 2024-175978 filed Oct. 7, 2024, the entire contents of which are incorporated herein by reference.

### FIELD OF THE DISCLOSURE

The present disclosure relates to an electrophotographic photoreceptor, a process cartridge, and an image forming apparatus.

### BACKGROUND OF THE DISCLOSURE

An electrophotographic photoreceptor is used as an image carrier in an electrophotographic image forming apparatus (e.g., a printer or a multifunction device). The electrophotographic photoreceptor includes a conductive base and a photosensitive layer. In the case of a stacked-type electrophotographic photoreceptor, the photosensitive layer includes a charge generating layer and a charge transporting layer. An intermediate layer is provided between the conductive base and the photosensitive layer in some cases.

In recent years, there has been a growing demand for cost reduction in image forming apparatuses. In order to achieve cost reduction, it is necessary to design photoreceptors at a low cost. In this regard, efforts has been made to reduce cost by thinning the photosensitive layer. For example, Japanese Patent Application Laid-open No. 2009-139643 discloses an electrophotographic photoreceptor that has favorable electrical properties and enabling the thinning of the charge transporting layer by using a predetermined triarylamine dimer compound as the photosensitive layer.

### SUMMARY OF THE DISCLOSURE

According to an embodiment of the present disclosure, there is provided an electrophotographic photoreceptor, including: a conductive base; an intermediate layer provided on the conductive base; and a photosensitive layer provided on the intermediate layer.

The intermediate layer includes titanium oxide and an intermediate layer resin, the titanium oxide having been subjected to no surface treatment with an inorganic material.

A content of the titanium oxide is 1.3 parts by mass or more and 1.7 parts by mass or less with respect to 1.0 part by mass of the intermediate layer resin.

A process cartridge according to an embodiment of the present disclosure includes: at least one selected from the group consisting of a charging device, an exposure device, a development device, a transfer device, a cleaning member, a rubbing roller, and a static elimination device; and the electrophotographic photoreceptor.

An image forming apparatus according to an embodiment of the present disclosure includes: an image carrier; a charging device; an exposure device; a development device; a transfer device; a cleaning member; and a static elimination device.

The charging device charges a surface of the image carrier.

The exposure device exposes the charged surface of the image carrier to form an electrostatic latent image on the surface of the image carrier.

The development device supplies a toner to the surface of the image carrier to develop the electrostatic latent image as a toner image.

The transfer device transfers the toner image from the image carrier to a to-be-transferred body.

The cleaning member cleans the surface of the image carrier.

The static elimination device eliminates static electricity on the surface of the image carrier.

The image carrier is the electrophotographic photoreceptor.

### BRIEF DESCRIPTION OF THE DRAWINGS

FIG. 1 is a partial cross-sectional view of a stacked xerographic photoreceptor that is an example of the xerographic photoreceptor according to the first embodiment of the present disclosure.

FIG. 2 is a partial cross-sectional view of a stacked xerographic photoreceptor that is an example of the xerographic photoreceptor according to the first embodiment of the present disclosure.

FIG. 3 is a partial cross-sectional view of a single-layer xerographic photoreceptor that is an example of the xerographic photoreceptor according to the first embodiment of the present disclosure.

FIG. 4 is a diagram showing an image forming apparatus according to a second embodiment of the present disclosure.

FIG. 5 is a diagram showing an example of a configuration of a development device shown in FIG. 4.

### DETAILED DESCRIPTION OF THE EXEMPLARY EMBODIMENTS

Thinning the photosensitive layer deteriorates the voltage resistance properties (hereinafter, referred to as voltage resistance). In order to suppress the deterioration of voltage resistance, it is effective to increase the electric resistance by reducing the ratio of the content of conductive fine particles to the content of the resin in the intermediate layer. However, in this case, a sensitivity difference due to particularly environmental differences (hereinafter, referred to as an environmental sensitivity difference) becomes large, and an image defect such as a faint image in a low-temperature and low-humidity environment and a dark image in a high-temperature and high-humidity environment occurs in some cases.

In view of the circumstances as described above, it is an object of the present disclosure to provide an electrophotographic photoreceptor having high voltage resistance and a small environmental sensitivity difference, and a process cartridge and an image forming apparatus including the electrophotographic photoreceptor.

Embodiments of the present disclosure will be described below. However, the present disclosure is not limited to the following embodiments and can be appropriately modified within the spirit of the present disclosure and carried out.

First, the terms used in the present specification will be described. Unless otherwise specified, the number average primary particle size is a number average value of an equivalent circle diameter (Heywood diameter: diameter of a circle having the same area as the projected area of a primary particle) of a primary particle measured using a scanning electron microscope. The number average primary particle size is, for example, a number average value of equivalent circle diameters of 100 primary particles. The term “-based” is added after the compound name to collectively refer to the compound and derivatives thereof in some cases. Further, in the case of adding the term “-based” after a compound to refer to a polymer name, it means that the repeating unit of the polymer is derived from the compound or a derivative thereof. Further, a “general formula” and a “chemical formula” are collectively referred to as a “formula”. Unless otherwise specified, the components described in the present specification may each be used alone, or two or more of them may be used in combination. The terms used in the present specification have been described above.

### First Embodiment: Electrophotographic Photoreceptor

### Overall Configuration

An electrophotographic photoreceptor according to a first embodiment of the present disclosure (hereinafter, referred to as a photoreceptor in some cases) will be described below. The photoreceptor according to this embodiment includes a conductive base, an intermediate layer provided on the conductive base, and a photosensitive layer provided on the intermediate layer. The intermediate layer includes titanium oxide and a resin used for the intermediate layer (intermediate layer resin), the titanium oxide having been subjected to no surface treatment with an inorganic material. The content of the titanium oxide is 1.3 parts by mass or more and 1.7 parts by mass or less with respect to 1.0 part by mass of the intermediate layer resin.

By having the above configuration, the photoreceptor according to this embodiment is capable of reducing the environmental sensitivity difference while ensuring favorable electrical properties and high voltage resistance. The reasons for this are presumed to be as follows.

First, by setting the content of titanium oxide in the intermediate layer at a certain level or higher, it is possible to improve electrical properties (sensitivity properties). Titanium oxide tends to provide more favorable sensitivity properties as compared with other inorganic particles (metal oxides, etc.). When the content of titanium oxide is too low, favorable sensitivity properties cannot be provided, so it is necessary to contain a predetermined amount or more of titanium oxide in the intermediate layer. In this regard, in the photoreceptor according to this embodiment, the content of titanium oxide is set to 1.3 parts by mass or more with respect to 1.0 part by mass of the intermediate layer resin. This allows favorable electrical properties to be provided.

Second, by setting the content of titanium oxide in the intermediate layer to a certain level or lower, it is possible to increase voltage resistance. For example, when the photosensitive layer is thinned, voltage resistance deteriorates. In order to improve voltage resistance, it is effective to reduce the content of titanium oxide that is conductive fine particles to increase electric resistance. In this regard, in the photoreceptor according to this embodiment, the content of titanium oxide is set to 1.7 parts by mass or less with respect to 1.0 part by mass of the intermediate layer resin. This allows high voltage resistance to be provided.

Third, by causing titanium oxide to be subjected to no surface treatment with an inorganic material, it is possible to reduce the environmental sensitivity difference while ensuring high voltage resistance. Titanium oxide that has been subjected to no surface treatment with an inorganic material does not include a conductive surface treatment agent, resulting in increased electric resistance and reduced susceptibility to environmental changes. By causing the intermediate layer to include such titanium oxide, it is possible to increase electric resistance and keep the environmental sensitivity difference small. In this regard, in the photoreceptor according to this embodiment, titanium oxide that has been subjected to no surface treatment with an inorganic material is included in the intermediate layer. As a result, it is possible to reduce the environmental sensitivity difference while ensuring high voltage resistance. Therefore, by having the above configuration, the photoreceptor according to this embodiment is capable of reducing the environmental sensitivity difference while ensuring favorable electrical properties and high voltage resistance.

The reason why the photoreceptor according to this embodiment is capable of reducing the environmental sensitivity difference while ensuring favorable electrical properties and high voltage resistance has been described above. The photoreceptor will be further described below.

The photoreceptor is, for example, a single-layer electrophotographic photoreceptor (hereinafter, referred to as a single-layer photoreceptor in some cases) or a stacked electrophotographic photoreceptor (hereinafter, referred to as a stacked photoreceptor in some cases).

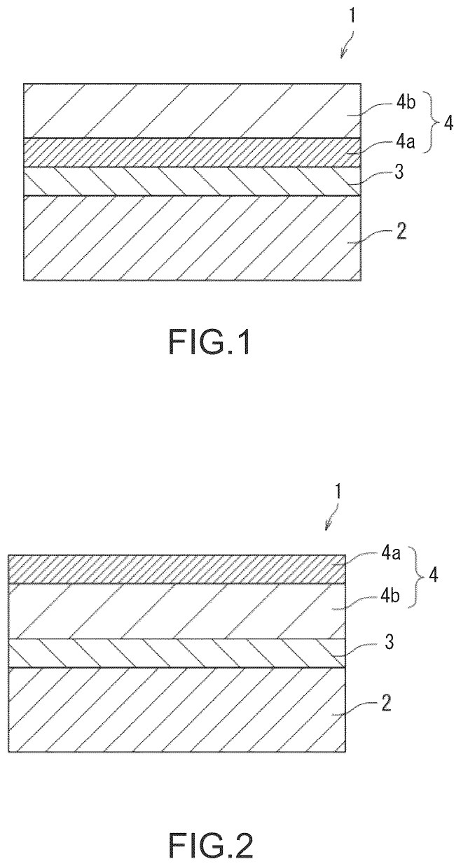

The structure of a stacked photoreceptor that is an example of a photoreceptor will be described below with reference to FIG. 1 and FIG. 2. FIG. 1 and FIG. 2 are each a partial cross-sectional view of the stacked photoreceptor 1.

As shown in FIG. 1, the stacked photoreceptor 1 according to this embodiment includes a conductive base 2, an intermediate layer 3, and a photosensitive layer 4. The intermediate layer 3 is provided on the conductive base 2. The photosensitive layer 4 is provided on the intermediate layer 3. The photosensitive layer 4 includes a charge generating layer 4a and a charge transporting layer 4b. That is, the stacked photoreceptor 1 includes, as the photosensitive layer 4, the charge generating layer 4a and the charge transporting layer 4b.

As shown in FIG. 1, the charge generating layer 4a may be provided on the intermediate layer 3 and the charge transporting layer 4b may be provided on the charge generating layer 4a. Alternatively, as shown in FIG. 2, the charge transporting layer 4b may be provided on the intermediate layer 3 and the charge generating layer 4a may be provided on the charge transporting layer 4b.

The stacked photoreceptor 1 may further include a protective layer (not shown) in addition to the conductive base 2, the intermediate layer 3, and the photosensitive layer 4. The protective layer is provided on the photosensitive layer 4. As shown in FIG. 1 and FIG. 2, the photosensitive layer 4 (e.g., the charge transporting layer 4b or the charge generating layer 4a) may be provided as the top surface layer of the stacked photoreceptor 1. Alternatively, the protective layer may be provided as the top surface layer of the stacked photoreceptor 1.

The structure of the stacked photoreceptor 1 that is an example of a photoreceptor has been described above with reference to FIG. 1 and FIG. 2.

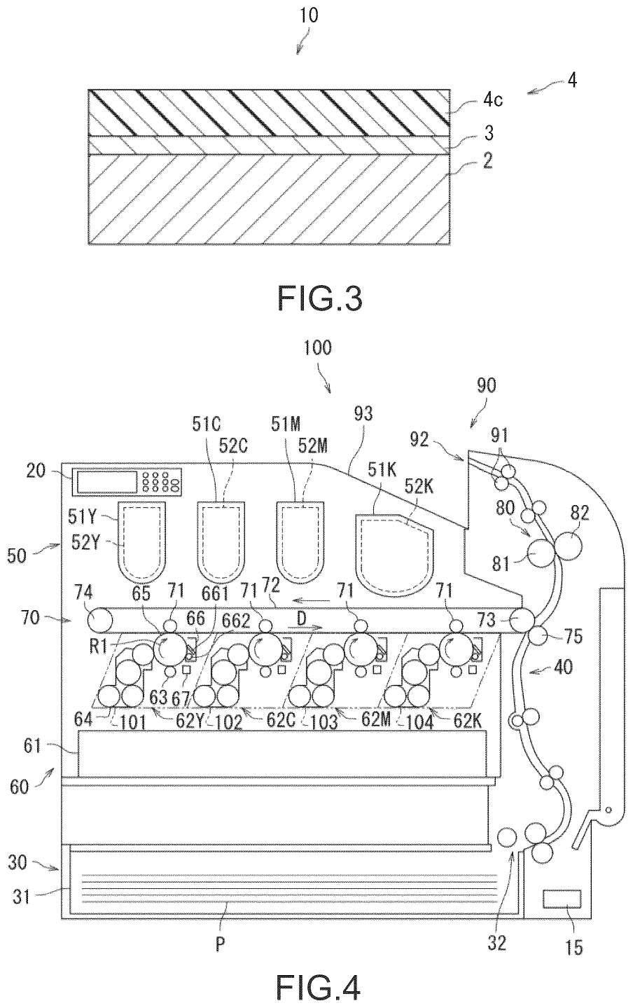

The structure of a single-layer photoreceptor 10 that is an example of a photoreceptor will be described below with reference to FIG. 3. FIG. 3 shows a partial cross-sectional view of the single-layer photoreceptor 10.

As shown in FIG. 3, the single-layer photoreceptor 10 according to this embodiment includes the conductive base 2, the intermediate layer 3, and the photosensitive layer 4. The intermediate layer 3 is provided on the conductive base 2. The photosensitive layer 4 is provided on the intermediate layer 3. The photosensitive layer 4 is a single layer. Hereinafter, the photosensitive layer 4 of a single layer will be referred to as a single-layer photosensitive layer 4c in some cases.

The photoreceptor 10 may further include a protective layer (not shown) in addition to the conductive base 2, the intermediate layer 3, and the single-layer photosensitive layer 4c. The protective layer is provided on the single-layer photosensitive layer 4c. As shown in FIG. 3, the single-layer photosensitive layer 4c may be provided as the top surface layer of the photoreceptor 10. Alternatively, the protective layer may be provided as the top surface layer of the photoreceptor 10.

The structure of the single-layer photoreceptor 10 that is an example of a photoreceptor has been described above with reference to FIG. 3.

Next, components constituting the photoreceptor according to this embodiment and constituent materials thereof will be described.

### (Conductive Base)

The conductive base is not particularly limited, and at least the surface portion thereof only needs to be formed of a material having conductivity. One example of the conductive base is a conductive base formed of a material having conductivity. Another example of the conductive base is a conductive base covered with a material having conductivity. Examples of the material having conductivity include aluminum, iron, copper, tin, platinum, silver, vanadium, molybdenum, chromium, cadmium, titanium, nickel, palladium, indium, stainless steel, and brass. These materials having conductivity may be used alone, or two or more of them may be used in combination (e.g., as an alloy). Of these material having conductivity, aluminum and an aluminum alloy are favorable because they allow charges to favorably transfer from the photosensitive layer to the conductive base.

The shape of the conductive base is appropriately selected in accordance with the structure of the image forming apparatus or the like. Examples of the shape of the conductive base include a sheet shape and a drum shape. Further, the thickness of the conductive base is appropriately selected in accordance with the shape of the conductive base.

### (Intermediate Layer)

The intermediate layer includes predetermined titanium oxide and a resin used for the intermediate layer (intermediate layer resin).

The predetermined titanium oxide is titanium oxide that has been subjected to no surface treatment with an inorganic material. Examples of the inorganic material include alumina, silica, zinc and zirconium. Further, the content of the predetermined titanium oxide in the intermediate layer is favorably 1.3 parts by mass or more and 1.7 parts by mass or less, more favorably 1.4 parts by mass or more and 1.6 parts by mass or less, with respect to 1 part by mass of the intermediate layer resin.

Examples of the intermediate layer resin include a thermoplastic resin (more specifically, a polyarylate resin, a polycarbonate resin, a styrene resin, styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallylphthalate resin, a ketone resin, a polyvinylbutyral resin, a polyvinylacetal resin, and a polyether resin), and a thermosetting resin (more specifically, a silicone resin, an epoxy resin, a phenolic resin, a urea resin, a melamine resin, and a cross-linkable thermosetting resin other than these). These resins may be used alone, or two or more of them may be used in combination. Further, of the above-mentioned resins, it is particularly favorable to use a polyamide resin. Note that in order to favorably form an intermediate layer and a photosensitive layer, it is favorable that the intermediate layer resin is different from the binder resin contained in the photosensitive layer.

The intermediate layer may include an additive. Examples of the additive include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. As the leveling agent, silicone oil is favorable and silicone oil having a dimethylpolysiloxane structure is more favorable.

Further, it is favorable to set the film thickness of the intermediate layer to a value within the range of 1.5 μm or more and 3.5 μm or less. When the film thickness of the intermediate layer is within this range, it is favorable from the viewpoint of providing desired voltage resistance. When the film thickness of the intermediate layer is a value less than 1.5 μm, it is not favorable from the viewpoint of voltage resistance. Meanwhile, when the film thickness of the intermediate layer is a value exceeding 3.5 μm, it is not favorable from the viewpoint of cost reduction.

### (Photosensitive Layer)

The photosensitive layer includes a charge generating agent, a hole transporting agent, and a binder resin. In the case where the photoreceptor is a single-layer photoreceptor, the single-layer photosensitive layer that is a photosensitive layer includes a charge generating agent, a hole transporting agent, and a binder resin. The single-layer photosensitive layer favorably further includes an electron transporting agent. The single-layer photosensitive layer may further include an additive, as necessary.

In the case where the photoreceptor is a stacked photoreceptor, the charge generating layer included in the photosensitive layer includes a charge generating agent. The charge transporting layer included in the photosensitive layer includes a hole transporting agent and a binder resin. The charge generating layer may further include a base resin, as necessary. Each of the charge generating layer and the charge transporting layer may further include an additive, as necessary. Each of the charge generating layer and the charge transporting layer may include a radical acceptor compound. However, each of the charge generating layer and the charge transporting layer does not necessarily need to include a radical acceptor compound.

### (Charge Generating Agent)

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of an inorganic photoconductive material (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment.

The phthalocyanine pigment has a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine. As the metal phthalocyanine, titanyl phthalocyanine is favorable. The titanyl phthalocyanine is represented by the following formula (CG-1). The metal-free phthalocyanine is represented by the following formula (CG-2).

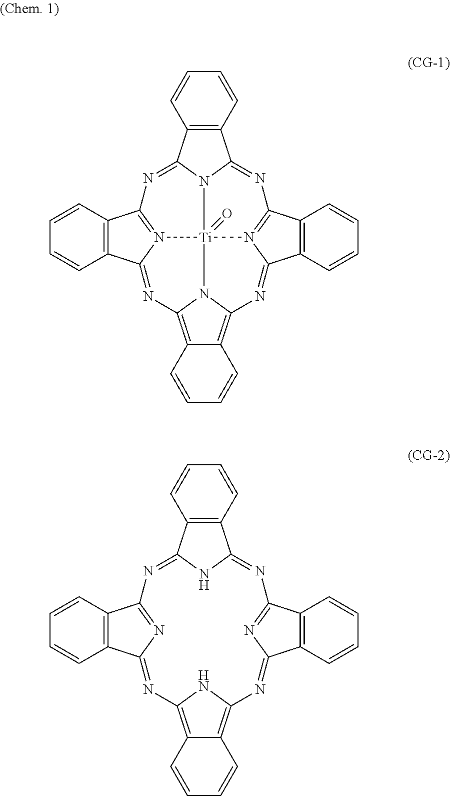

The phthalocyanine pigment may be crystalline or non-crystalline. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include α-type, β-type, and Y-type crystals of the titanyl phthalocyanine (hereinafter, respectively referred to as α-type, β-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, titanyl phthalocyanine or metal-free phthalocyanine is more favorable, and Y-type titanyl phthalocyanine or X-type metal-free phthalocyanine is particularly favorable because they have a high quantum yield in the wavelength region of 700 nm or more.

The Y-type titanyl phthalocyanine has a main peak at, for example, 27.2° of the Bragg angle (2θ±0.2° in the CuKα characteristic X-ray diffraction spectrum. The main peak in the CuKα characteristic X-ray diffraction spectrum is a peak having the first or second highest intensity in the range of the Bragg angle (2θ±0.2° of 3° or more and 40° or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (2θ) is, for example, 3° or more and 40° or less (start angle of 3°, stop angle of) 40°, and the scanning speed is, for example, 10°/min. The main peak is determined from the obtained X-ray diffraction spectrum, and the Bragg angle of the main peak is read.

In the case where the photoreceptor is a single-layer photoreceptor, the content of the charge generating agent in the single-layer photosensitive layer that is a photosensitive layer is favorably 0.1 part by mass or more and 50 parts by mass or less, more favorably 0.5 parts by mass or more and 30 parts by mass or less, with respect to 10 parts by mass of the binder resin. In the case where the photoreceptor is a stacked photoreceptor, the content of the charge generating agent in the photosensitive layer (specifically, the charge generating layer) is favorably 10 parts by mass or more and 30 parts by mass or less, more favorably 10 parts by mass or more and 20 parts by mass or less, with respect to 10 parts by mass of the base resin.

### (Hole Transporting Agent)

Examples of the hole transporting agent include a triphenylamine derivative, a diamine derivative (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenanthrylenediamine derivative, and a di(aminophenylethenyl)benzene derivative)), an oxadiazole compound (e.g., 2,5-di(4-methylaminophenyl)-1,3,4-oxadiazole), a styryl compound (e.g., 9-(4-diethylaminostyryl) anthracene), a carbazole compound (e.g., polyvinylcarbazole), an organic polysilane compound, a pyrazoline compound (e.g., 1-phenyl-3-(p-dimethylaminophenyl) pyrazoline), a hydrazone compound, an indole compound, an oxazole compound, an isooxazole compound, a thiazole compound, a thiadiazole compound, an imidazole compound, a pyrazole compound, and a triazole compound.

In the case where the photoreceptor is a single-layer photoreceptor, the content of the hole transporting agent in the single-layer photosensitive layer that is a photosensitive layer is favorably 10 parts by mass or more and 130 parts by mass or less, more favorably 20 parts by mass or more and 40 parts by mass or less, with respect to 10 parts by mass of the binder resin.

In order to improve the sensitivity properties of the photoreceptor, in the case where the photoreceptor is a single-layer photoreceptor, the total content ratio of the hole transporting agent and the electron transporting agent occupied in the single-layer photosensitive layer is favorably 40 mass % or more, more favorably 40 mass % or more and 60 mass % or less, with respect to the mass of the single-layer photosensitive layer.

In the case where the photoreceptor is a single-layer photoreceptor, the thickness of the single-layer photosensitive layer is not particularly limited, but is favorably 5 μm or more and 100 μm or less, more favorably 10 μm or more and 50 μm or less.

In the case where the photoreceptor is a stacked photoreceptor, the content of the hole transporting agent occupied in the photosensitive layer (specifically, the charge transporting layer) is favorably 10 parts by mass or more and 50 parts by mass or less, more favorably 10 parts by mass or more and 20 parts by mass or less, with respect to 10 parts by mass of the binder resin.

In order to improve the sensitivity properties of the photoreceptor, in the case where the photoreceptor is a stacked photoreceptor, the content ratio of the hole transporting agent occupied in the charge transporting layer is favorably 40 mass % or more, more favorably 40 mass % or more and 60 mass % or less, with respect to the mass of the charge transporting layer.

In the case where the photoreceptor is a stacked photoreceptor, the thickness of the charge generating layer is not particularly limited, but is favorably 0.01 μm or more and 5 μm or less, more favorably 0.1 μm or more and 3 μm or less.

In the case where the photoreceptor is a stacked photoreceptor, the thickness of the charge transporting layer is not particularly limited, but is favorably 2 μm or more and 100 μm or less, more favorably 5 μm or more and 50 μm or less.

### (Electron Transporting Agent)

Examples of the electron transporting agent include a quinone compound, a diimide compound, a hydrazone compound, a malononitrile compound, a thiopyran compound, a trinitrothioxanthone compound, a 3,4,5,7-tetranitro-9-fluorenone compound, a dinitroanthracene compound, a dinitroacridine compound, tetracyanoethylene, 2,4,8-trinitrothioxanthone, dinitrobenzene, dinitroacridine, succinic anhydride, maleic anhydride, and dibromomaleic anhydride. Examples of the quinone compound include a diphenoquinone compound, an azoquinone compound, an anthraquinone compound, a naphthoquinone compound, a nitroanthraquinone compound, and a dinitroanthraquinone compound.

In the case where the photoreceptor is a single-layer photoreceptor, the content of the electron transporting agent in the single-layer photosensitive layer that is a photosensitive layer is favorably 5 parts by mass or more and 150 parts by mass or less, more favorably 10 parts by mass or more and 50 parts by mass or less, with respect to 10 parts by mass of the binder resin.

### (Binder Resin)

Examples of the binder resin include a thermoplastic resin (more specifically, a polyarylate resin, a polycarbonate resin, a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallylphthalate resin, a ketone resin, a polyvinylbutyral resin, a polyvinylacetal resin, and a polyether resin), a thermosetting resin (more specifically, a silicone resin, an epoxy resin, a phenolic resin, a urea resin, a melamine resin, and a cross-linkable thermosetting resin other than these), and a photocurable resin (more specifically, an epoxy-acrylic acid resin and a urethane-acrylic acid copolymer).

Of these resins, a polycarbonate resin is favorable because a single-layer photosensitive layer and a charge transporting layer having an excellent balance of workability, mechanical strength, optical characteristics, and wear resistance can be obtained. Examples of the polycarbonate resin include a bisphenol Z-type polycarbonate resin, a bisphenol B-type polycarbonate resin, a bisphenol ZC-type polycarbonate resin, a bisphenol C-type polycarbonate resin, and a bisphenol A-type polycarbonate resin. As the binder resin, a bisphenol Z-type polycarbonate resin or a bisphenol B-type polycarbonate resin is favorable. The bisphenol Z-type polycarbonate resin is a resin including a repeating unit represented by the formula (BisZ). The bisphenol B-type polycarbonate resin is a resin including a repeating unit represented by the formula (BisB).

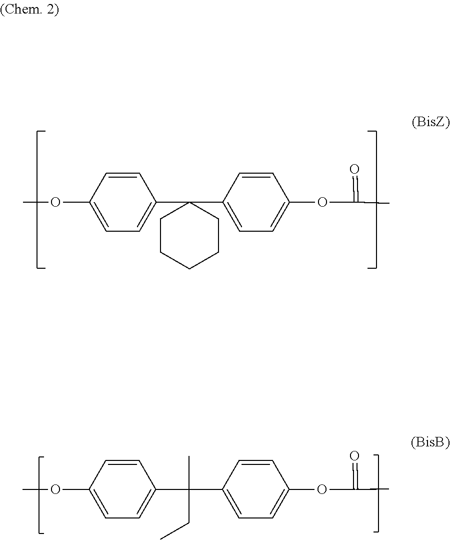

### (Base Resin)

Examples of the base resin included in the charge generating layer are the same as the examples of the binder resin included in the charge transporting layer. However, in order to suitably form a charge generating layer and a charge transporting layer, it is favorable to select, as a base resin, a resin different from the resin used as the binder resin, of the above examples of the binder resin. The base resin is, for example, a polyvinylacetal resin.

### (Additive)

Examples of the additive include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. As the leveling agent, silicone oil is favorable and silicone oil having a dimethylpolysiloxane structure is more favorable.

According to this embodiment, it is possible to obtain a photoreceptor having favorable electrical properties, high voltage resistance, and a small environmental sensitivity difference. That is, according to the photoreceptor according to this embodiment, it is possible to prevent an image defect due to an environmental sensitivity difference, such as a faint image in a low-temperature and low-humidity environment and a dark image in a high-temperature and high-humidity environment, from occurring.

The electrophotographic photoreceptor according to the first embodiment of the present disclosure has been described above.

### (Method of Producing Photoreceptor)

Next, an example of a method of producing the photoreceptor according to the first embodiment will be described. The method of producing the photoreceptor according to the first embodiment includes, for example, an intermediate layer forming step and a photosensitive layer forming step.

### (Intermediate Layer Forming Step)

In the intermediate layer forming step, a coating liquid for forming an intermediate layer (hereinafter, referred to as a coating liquid for an intermediate layer in some cases) is prepared. The coating liquid for an intermediate layer includes predetermined titanium oxide, an intermediate layer resin, a solvent, and an additive as necessary. The coating liquid for an intermediate layer is prepared by mixing these. Subsequently, the coating liquid for an intermediate layer is applied onto a conductive base. Subsequently, at least part of the solvent included in the applied coating liquid for an intermediate layer is removed to form an intermediate layer.

### (Step of Forming Photosensitive Layer of Stacked Photoreceptor)

A photosensitive layer forming step in the case where the photoreceptor is a stacked photoreceptor will be described. The step of forming a photosensitive layer of a stacked photoreceptor includes a charge generating layer forming step and a charge transporting layer forming step.

In the charge generating layer forming step, a coating liquid for forming a charge generating layer (hereinafter, referred to as a coating liquid for a charge generating layer in some cases) is prepared. The coating liquid for a charge generating layer includes, for example, a charge generating agent, a base resin, a solvent, and an additive as necessary. The coating liquid for a charge generating layer is prepared by mixing these. Subsequently, the coating liquid for a charge generating layer is applied onto the intermediate layer. Subsequently, at least part of the solvent included in the applied coating liquid for a charge generating layer is removed to form a charge generating layer.

In the charge transporting layer forming step, a coating liquid for forming a charge transporting layer (hereinafter, referred to as a coating liquid for a charge transporting layer in some cases) is prepared. The coating liquid for a charge transporting layer includes a hole transporting agent, a binder resin, a solvent, and an additive as necessary. The coating liquid for a charge transporting layer is prepared by mixing these. Subsequently, the coating liquid for a charge transporting layer is applied onto the charge generating layer. Subsequently, at least part of the solvent included in the applied coating liquid for a charge transporting layer is removed to form a charge transporting layer.

### (Step of Forming Photosensitive Layer of Single-Layer Photoreceptor)

A photosensitive layer forming step in the case where the photoreceptor is a single-layer photoreceptor will be described. The step of forming a photosensitive layer of a single-layer photoreceptor includes a single-layer photosensitive layer forming step. In the single-layer photosensitive layer forming step, a coating liquid for forming a single-layer photosensitive layer (hereinafter, referred to as a coating liquid for a single-layer photosensitive layer in some cases) is prepared. The coating liquid for a single-layer photosensitive layer includes, for example, a charge generating agent, a hole transporting agent, a binder resin, a solvent, an electron transporting agent as necessary, and an additive as necessary. The coating liquid for a single-layer photosensitive layer is prepared by mixing these. Subsequently, the coating liquid for a single-layer photosensitive layer is applied onto the intermediate layer. Subsequently, at least part of the solvent included in the applied coating liquid for a photosensitive layer is removed to form a single-layer photosensitive layer.

The solvent included in the coating liquid for an intermediate layer, the coating liquid for a charge generating layer, the coating liquid for a charge transporting layer, and the coating liquid for a single-layer photosensitive layer (hereinafter, collectively referred to as a coating liquid in some cases) is not particularly limited as long as it is capable of dissolving each component included in the coating liquid. Examples of the solvent include an alcohol (more specifically, methanol, ethanol, isopropanol, and butanol, etc.), an aliphatic hydrocarbon (more specifically, n-hexane, octane, and cyclohexane, etc.), an aromatic hydrocarbon (more specifically, benzene, toluene, and xylene, etc.), a halogenated hydrocarbon (more specifically, methylene chloride, chloroform, ethylene chloride, dichloromethane, dichloroethane, carbon tetrachloride, and chlorobenzene, etc.), an ether (more specifically, dioxane, dimethyl ether, diethyl ether, tetrahydrofuran, ethylene glycol dimethyl ether, propylene glycol monomethyl ether, and diethylene glycol dimethyl ether, etc.), a ketone (more specifically, acetone, methyl ethyl ketone, 2-butanone, and cyclohexanone, etc.), an ester (more specifically, ethyl acetate and methyl acetate, etc.), dimethylformaldehyde, dimethylformamide, and dimethylsulfoxide.

The solvent included in the coating liquid for a charge transporting layer is favorably different from the solvent included in the coating liquid for a charge generating layer. This is because when the coating liquid for a charge transporting layer is applied onto the charge generating layer, it is favorable that the charge generating layer is not dissolved in the solvent in the coating liquid for a charge transporting layer.

The coating liquid is prepared by mixing the respective components and dispersing them in the solvent. For the mixing or dispersion, for example, a bead mill, a roll mill, a ball mill, an attrition mil, a paint shaker, or an ultrasonic disperser can be used.

The method of applying the coating liquid is not particularly limited as long as the coating liquid can be uniformly applied. Examples of the application method include a dip coating method, a spray coating method, a spin coating method, and a bar coating method.

Examples of the method of removing at least part of the solvent included in the coating liquid include heating, reduction of pressure, and a combination of heating and reduction of pressure. More specifically, a method of performing heat treatment (hot air drying) using a high-temperature dryer or a reduced-pressure dryer can be used. The temperature of the heat treatment is, for example, 40° C. or more and 150° C. or less. The time for the heat treatment is, for example, 3 minutes or more and 120 minutes or less.

Note that the method of producing the photoreceptor according to the first embodiment may further include a protective layer forming step as necessary. The protective layer forming step may be performed by appropriately selecting and implementing a known method.

### Second Embodiment: Image Forming Apparatus

Next, an image forming apparatus 100 that is an example of an image forming apparatus according to a second embodiment of the present disclosure will be described with reference to FIG. 4. FIG. 4 is a diagram showing an example of the configuration of the image forming apparatus 100. The image forming apparatus 100 is, for example, a tandem-type color printer.

As shown in FIG. 4, the image forming apparatus 100 includes a control unit 15, an operation unit 20, a paper feed unit 30, a conveying unit 40, a toner supply unit 50, an image forming unit 60, a transfer device 70, a fixing device 80, and an output unit 90.

The control unit 15 controls the operation of the respective units of the image forming apparatus 100. The control unit 15 includes a processor (not shown) and a storage unit (not shown). The processor includes, for example, a central processing unit (CPU). The storage unit includes a memory such as a semiconductor memory, and may include a hard disk drive (HDD). The processor executes a control program to control the operation of the image forming apparatus 100. The storage unit stores the control program.

The operation unit 20 accepts an instruction from a user. The operation unit 20 transmits, upon accepting an instruction from a user, a signal indicating the instruction from a user to the control unit 15. As a result, an image forming operation by the image forming apparatus 100 is started.

The paper feed unit 30 includes a paper feed cassette 31 and a paper feed roller group 32. The paper feed cassette 31 is capable of housing a plurality of recording media P (e.g., sheets of paper). The paper feed roller group 32 feeds the recording media P housed in the paper feed cassette 31 to the conveying unit 40 one sheet at a time.

The conveying unit 40 includes a roller and a guide member. The conveying unit 40 extends from the paper feed unit 30 to the output unit 90. The conveying unit 40 conveys the recording medium P from the paper feed unit 30 to the output unit 90 through the image forming unit 60 and the fixing device 80.

The toner supply unit 50 supplies a toner to the image forming unit 60. The toner supply unit 50 includes a first mounting portion 51Y, a second mounting portion 51C, a third mounting portion 51M, and a fourth mounting portion 51K.

A first toner container 52Y is mounted on the first mounting portion 51Y. Similarly, a second toner container 52C, a third toner container 52M, and a fourth toner container 52K are respectively mounted on the second mounting portion 51C, the third mounting portion 51M, and the fourth mounting portion 51K.

A toner is housed in each of the first toner container 52Y, the second toner container 52C, the third toner container 52M, and the fourth toner container 52K. In the second embodiment, a yellow toner is housed in the first toner container 52Y. A cyan toner is housed in the second toner container 52C. A magenta toner is housed in the third toner container 52M. A black toner is housed in the fourth toner container 52K.

The image forming unit 60 includes an exposure device 61, a first image formation unit 62Y, a second image formation unit 62C, a third image formation unit 62M, and a fourth image formation unit 62K.

Each of the first image formation unit 62Y to the fourth image formation unit 62K includes a charging device 63, a development device 64, an image carrier 65, a cleaning device 66, and a static elimination device 67.

Note that regarding the configurations of the first image formation unit 62Y to the fourth image formation unit 62K, only the type of toner to be supplied from the toner supply unit 50 differs and the other configurations are the same. For this reason, in FIG. 4, the configuration of each of the second image formation unit 62C to the fourth image formation unit 62K is shown with reference symbols omitted.

The image carrier 65 is the photoreceptor according to the first embodiment (more specifically, the stacked photoreceptor 1 or the single-layer photoreceptor 10). As described in the first embodiment, the photoreceptor according to the first embodiment is capable of preventing an image defect due to an environmental sensitivity difference, such as a faint image in a low-temperature and low-humidity environment and a dark image in a high-temperature and high-humidity environment, from occurring. Therefore, the image forming apparatus 100 according to the second embodiment is capable of preventing an image defect due to an environmental sensitivity difference, such as a faint image in a low-temperature and low-humidity environment and a dark image in a high-temperature and high-humidity environment, from occurring.

In the second embodiment, the image carrier 65 rotates in the direction indicated by an arrow R1 in FIG. 4 (clockwise direction in FIG. 4). The charging device 63, the development device 64, the cleaning device 66, and the static elimination device 67 are disposed along the circumferential surface of the image carrier 65 in the order described from the upstream side in the rotation direction of the image carrier 65.

The charging device 63 charges the surface (circumferential surface) of the image carrier 65. The charging device 63 uniformly charges the image carrier 65 to predetermined polarity by electric discharge. The charging device 63 is, for example, a charging roller.

The exposure device 61 exposes the charged surface of the image carrier 65. In detail, the exposure device 61 applies laser light to the charged surface of the image carrier 65. In this way, an electrostatic latent image is formed on the surface of the image carrier 65.

A toner is supplied from the toner supply unit 50 to the development device 64. The development device 64 supplies the toner supplied from the toner supply unit 50 to the surface of the image carrier 65. As a result, the electrostatic latent image formed on the surface of the image carrier 65 is developed as a toner image.

In the second embodiment, the development device 64 of the first image formation unit 62Y is connected to the first toner container 52Y. For this reason, a yellow toner is supplied to the development device 64 of the first image formation unit 62Y. Therefore, a yellow toner image is formed on the surface of the image carrier 65 of the first image formation unit 62Y.

Similarly, the development device 64 of the second image formation unit 62C, the development device 64 of the third image formation unit 62M, and the development device 64 of the fourth image formation unit 62K are respectively connected to the second toner container 52C, the third toner container 52M, and the fourth toner container 52K. For this reason, a cyan toner, a magenta toner, and a black toner are respectively supplied to the development device 64 of the second image formation unit 62C, the development device 64 of the third image formation unit 62M, and the development device 64 of the fourth image formation unit 62K. Therefore, a cyan toner image, a magenta toner image, and a black toner image are respectively formed on the surface of the image carrier 65 of the second image formation unit 62C, the surface of the image carrier 65 of the third image formation unit 62M, and the surface of the image carrier 65 of the fourth image formation unit 62K.

The cleaning device 66 includes a cleaning member 661 and a rubbing roller 662. After transfer by a primary transfer roller 71 described below, the cleaning member 661 is pressed against the surface of the image carrier 65 to collect the toner adhering to the surface of the image carrier 65. The cleaning member 661 is, for example, a cleaning blade. The rubbing roller 662 rubs the surface of the image carrier 65 to polish the surface of the image carrier 65.

The static elimination device 67 applies static elimination light to the surface of the image carrier 65 to eliminate static electricity on the surface of the image carrier 65.

The transfer device 70 transfers a toner image from the image carrier 65 to the recording medium P that is a to-be-transferred body. In detail, the transfer device 70 transfers each toner image formed on the surface of each image carrier 65 of the first image formation unit 62Y to the fourth image formation unit 62K onto the recording medium P in a superimposed manner. In the second embodiment, the transfer device 70 transfers each toner image onto the recording medium P in a superimposed manner using a secondary transfer method (intermediate transfer method). The transfer device 70 includes four primary transfer rollers 71, an intermediate transfer belt 72, a drive roller 73, a driven roller 74, and a secondary transfer roller 75.

The intermediate transfer belt 72 is an endless belt stretched over the four primary transfer rollers 71, the drive roller 73, and the driven roller 74. The intermediate transfer belt 72 is driven in accordance with rotation of the drive roller 73. The intermediate transfer belt 72 rotates counterclockwise in FIG. 4. The driven roller 74 is driven to rotate in accordance with the drive of the intermediate transfer belt 72.

The first image formation unit 62Y to the fourth image formation unit 62K are disposed to face the lower surface of the intermediate transfer belt 72. In the second embodiment, the first image formation unit 62Y to the fourth image formation unit 62K are disposed in the order of the first image formation unit 62Y to the fourth image formation unit 62K from the upstream side to the downstream side in a drive direction D of the lower surface of the intermediate transfer belt 72.

Each primary transfer roller 71 is disposed to face the corresponding image carrier 65 via the intermediate transfer belt 72 and is pressed toward the image carrier 65. For this reason, the toner image formed on the surface of each image carrier 65 by each primary transfer roller 71 is sequentially transferred onto the intermediate transfer belt 72. In the second embodiment, a yellow toner image, a cyan toner image, a magenta toner image, and a black toner image are transferred onto the intermediate transfer belt 72 in this order in a superimposed manner. Hereinafter, the toner image obtained by superimposing a yellow toner image, a cyan toner image, a magenta toner image, and a black toner image will be referred to as a “stacked toner image” in some cases.

The secondary transfer roller 75 is disposed to face the drive roller 73 via the intermediate transfer belt 72. The secondary transfer roller 75 is pressed toward the drive roller 73. This forms a transfer nip between the secondary transfer roller 75 and the drive roller 73. When the recording medium P passes through the transfer nip, the stacked toner image on the intermediate transfer belt 72 is transferred onto the recording medium P by the secondary transfer roller 75. In the second embodiment, a yellow toner image, a cyan toner image, a magenta toner image, and a black toner image are transferred onto the recording medium P in this order as the top layer to the bottom layer. The recording medium P onto which the stacked toner image has been transferred is conveyed toward the fixing device 80 by the conveying unit 40.

The fixing device 80 includes a heating member 81 and a pressure member 82. The heating member 81 and the pressure member 82 are disposed to face each other to form a fixing nip. The recording medium P conveyed from the image forming unit 60 is pressurized while being heated at a predetermined fixing temperature by passing through the fixing nip. As a result, the stacked toner image is fixed to the recording medium P. The recording medium P is conveyed from the fixing device 80 to the output unit 90 by the conveying unit 40.

The output unit 90 includes an output roller pair 91 and an output tray 93. The output roller pair 91 conveys the recording medium P to the output tray 93 via an output port 92. The output port 92 is formed in the upper part of the image forming apparatus 100.

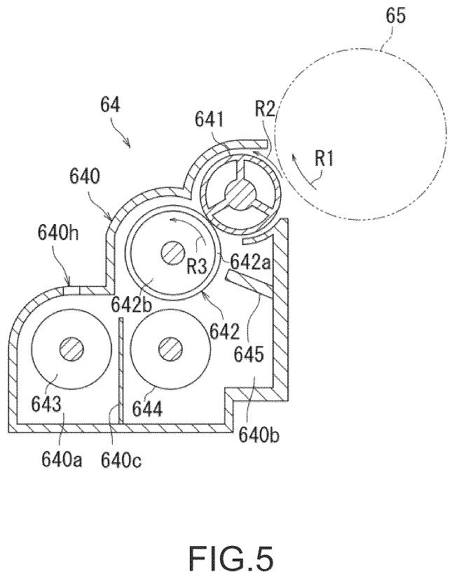

Next, the configuration of the development device 64 will be described in detail with reference to FIG. 5. FIG. 5 is a diagram showing an example of the configuration of the development device 64. In detail, FIG. 5 shows the development device 64 of the first image formation unit 62Y. Note that in FIG. 5, the image carrier 65 is illustrated with a two-dot chain line for ease of understanding. In the second embodiment, the development device 64 adopts a two-component development method using a two-component developer and a touch-down development method.

As described above with reference to FIG. 4, a development container 640 of the development device 64 is connected to the first toner container 52Y. Therefore, a yellow toner is supplied to the development container 640 of the development device 64 via a toner supply port 640h.

As shown in FIG. 5, the development device 64 includes, inside the development container 640, a development roller 641, a magnetic roller 642, a first stirring screw 643, a second stirring screw 644, and a blade 645. In detail, the development roller 641 is disposed to face the magnetic roller 642. The magnetic roller 642 is disposed to face the second stirring screw 644. The blade 645 is disposed to face the magnetic roller 642.

The development container 640 is divided into a first stirring chamber 640a and a second stirring chamber 640b by a partition wall 640c. The partition wall 640c extends in the axial direction of the development roller 641. The first stirring chamber 640a and the second stirring chamber 640b communicate with each other on the outside at both ends of the partition wall 640c in the longitudinal direction.

The first stirring screw 643 is disposed in the first stirring chamber 640a. A carrier that is a magnetic material is housed in the first stirring chamber 640a. A toner that is a non-magnetic material is supplied to the first stirring chamber 640a via the toner supply port 640h. In the example shown in FIG. 5, a yellow toner is supplied to the first stirring chamber 640a.

The second stirring screw 644 is disposed in the second stirring chamber 640b. A carrier that is a magnetic material is housed in the second stirring chamber 640b.

The yellow toner is stirred with the carrier by the first stirring screw 643 and the second stirring screw 644. As a result, a two-component developer that includes a carrier and a yellow toner is formed. In this way, the two-component developer is housed in the development container 640 (more specifically, the first stirring chamber 640a and the second stirring chamber 640b).

The first stirring screw 643 and the second stirring screw 644 stir the two-component developer while circulating it between the first stirring chamber 640a and the second stirring chamber 640b. As a result, the toner is charged to predetermined polarity by friction with the carrier.

Note that in the case where the image carrier 65 is the stacked photoreceptor 1, the surface of the image carrier 65 and the toner are charged to, for example, positive polarity. In the case where the image carrier 65 is the single-layer photoreceptor 10, the surface of the image carrier 65 and the toner are charged to, for example, negative polarity.

The magnetic roller 642 includes a non-magnetic rotating sleeve 642a and a magnet body 642b. The magnet body 642b is fixed to and disposed in the rotating sleeve 642a. The magnet body 642b includes a plurality of magnetic poles. The two-component developer is attracted to the magnetic roller 642 by the magnetic force of the magnet body 642b. As a result, a magnetic brush is formed on the surface of the magnetic roller 642.

The blade 645 is disposed on the upstream side in the rotation direction of the magnetic roller 642 than the position where the magnetic roller 642 and the development roller 641 face each other. In the second embodiment, the magnetic roller 642 rotates in the direction indicated by an arrow R3 in FIG. 5 (counterclockwise direction in FIG. 5). The magnetic roller 642 rotates to convey the magnetic brush to the position facing the blade 645. The blade 645 is disposed such that a gap is formed between the blade 645 and the magnetic roller 642. The blade 645 is formed of a magnetic material. Therefore, the thickness of the magnetic brush is regulated by the magnetic force of the blade 645.

After the thickness of the magnetic brush on the magnetic roller 642 is regulated, a predetermined voltage is applied to the magnetic roller 642 and the development roller 641. When the predetermined voltage is applied to obtain a predetermined potential difference between the magnetic roller 642 and the development roller 641, the yellow toner included in the two-component developer migrates to the development roller 641. As a result, the toner thin layer including the yellow toner is formed on the surface of the development roller 641.

The development roller 641 rotates in the direction indicated by an arrow R2 in FIG. 5 (counterclockwise direction in FIG. 5). This causes the toner thin layer formed on the surface of the development roller 641 to be conveyed to the position facing the image carrier 65 and adhere to the image carrier 65. In this way, the development device 64 supplies the toner charged due to the friction with the carrier to the surface of the image carrier 65.

The development device 64 of the first image formation unit 62Y has been described above with reference to FIG. 5. Regarding the configuration of the development device 64 of each of the first image formation unit 62Y to the fourth image formation unit 62K, only the type of toner to be supplied from the toner supply unit 50 differs and the other configurations are the same. For this reason, description of the configuration of the development device 64 of each of the second image formation unit 62C to the fourth image formation unit 62K is omitted.

The image forming apparatus 100 that is an example of the image forming apparatus according to the second embodiment has been described above with reference to FIG. 4 and FIG. 5. However, the image forming apparatus according to the second embodiment is not limited to the image forming apparatus 100. For example, the image forming apparatus may be a monochrome image forming apparatus. In this case, the image forming apparatus only needs to include one image formation unit. The image forming apparatus may adopt a rotary method. The charging device may be a charging device other than the charging roller (e.g., a scorotron charger, a charging brush, or a corotron charger). The image forming apparatus may adopt a one-component development method using a one-component developer. The image forming apparatus may adopt a development method other than the touch-down development method (e.g., a development method in which no development roller is provided and a magnetic roller serves also as a development roller). The image forming apparatus may adopt a direct transfer method. In the case where the image forming apparatus adopts a direct transfer method, a toner image is directly transferred to a recording medium from an image carrier while the image carrier is in contact with the recording medium. The image forming apparatus does not necessarily need to include a cleaning device. The image forming apparatus does not necessarily need to include a static elimination device. The image forming apparatus according to the second embodiment has been described above.

### Third Embodiment: Process Cartridge

Next, a first process cartridge 101, a second process cartridge 102, a third process cartridge 103, and a fourth process cartridge 104 that are examples of a process cartridge according to a third embodiment of the present disclosure will be described with continued reference to FIG. 4. The first process cartridge 101 to the fourth process cartridge 104 according to the third embodiment respectively correspond to the first image formation unit 62Y to the fourth image formation unit 62K. Each of the first process cartridge 101 to the fourth process cartridge 104 includes the image carrier 65. The image carrier 65 is the photoreceptor according to the first embodiment (more specifically, the stacked photoreceptor 1 or the single-layer photoreceptor 10).

As described in the first embodiment, the photoreceptor according to the first embodiment is capable of preventing an image defect due to an environmental sensitivity difference, such as a faint image in a low-temperature and low-humidity environment and a dark image in a high-temperature and high-humidity environment, from occurring. Therefore, the process cartridge according to the third embodiment including the photoreceptor according to the first embodiment is capable of preventing an image defect due to an environmental sensitivity difference, such as a faint image in a low-temperature and low-humidity environment and a dark image in a high-temperature and high-humidity environment, from occurring.

The process cartridge according to the third embodiment may further include at least one (e.g., 1 or more and 7 or less) selected from the group consisting of the charging device 63, the exposure device 61, the development device 64, the transfer device 70 (particularly, the primary transfer roller 71), the cleaning member 661, the rubbing roller 662, and the static elimination device 67, in addition to the image carrier 65.

The first process cartridge 101, the second process cartridge 102, the third process cartridge 103, and the fourth process cartridge 104 shown in FIG. 4 includes the image carrier 65, the charging device 63, the development device 64, the cleaning device 66 that includes the cleaning member 661 and the rubbing roller 662, and the static elimination device 67, similarly to the first image formation unit 62Y, the second image formation unit 62C, the third image formation unit 62M, and the fourth image formation unit 62K, respectively. However, the process cartridge according to the third embodiment is not limited to the first process cartridge 101 to the fourth process cartridge 104. As described above, the process cartridge according to the third embodiment may further include at least one of the exposure device 61 or the transfer device 70 and may include only one of the cleaning member 661 and the rubbing roller 662 (e.g. only the cleaning member 661). In any case, the process cartridge according to the third embodiment only needs to include the photoreceptor according to the first embodiment as the image carrier 65.

The process cartridge according to the third embodiment is designed to be attachable/detachable to/from the image forming apparatus 100. For this reason, the process cartridge is easy to handle, and can be easily and quickly replaced together with the image carrier 65 in the case where the sensitivity properties or the like of the image carrier 65 deteriorate. The process cartridge according to the third embodiment has been described above with reference to FIG. 4.

### OTHER EMBODIMENTS

Although embodiments of the present disclosure have been described above, it goes without saying that the present disclosure is not limited to the above-mentioned embodiments and various modifications can be made.

### Examples and Comparative Examples

Although Examples of the present disclosure will be described below, the present disclosure is not limited to these Examples.

### (Production of Stacked Photoreceptor for Evaluation)

A stacked photoreceptor for evaluation (photoreceptor according to Example 1) was produced as follows.

First, as a conductive base, a drum-shaped support that has a diameter of 30 mm and is formed of aluminum was prepared. Next, 1.5 parts by mass of titanium oxide that has been subjected to surface treatment with methylhydrogenpolysiloxane while being wet dispersed (“MTX-00S” manufactured by TAYCA Co., Ltd., a number average primary particle size of 10 nm), 1 part by mass of a polyamide resin (“Amilan (registered trademark) CM8000” manufactured by TORAY INDUSTRIES, INC., a quaternary copolymerized polyamide resin of polyamide 6, polyamide 12, polyamide 66, and polyamide 610), 10 parts by mass of methanol, 1 part by mass of butanol, and 1 part by mass of toluene were mixed using a bead mill for 5 hours to obtain a coating liquid for an intermediate layer. The obtained coating liquid for an intermediate layer was filtered using a filter with an opening of 5 μm. After that, the obtained filtrate was applied onto the surface of the conductive base by a dip coating method. Subsequently, the applied filtrate was dried at 130° C. for 30 minutes. In this way, an intermediate layer (film thickness: 2.5 μm) was formed on the conductive base.

Next, 1.5 parts by mass of a Y-type titanyl phthalocyanine that is a charge generating agent, 1.0 part by mass of a polyvinylacetal resin (“S-LEC BX-5” manufactured by SEKISUI CHEMICAL CO., LTD.) as a base resin, 40.0 parts by mass of propylene glycol monomethyl ether, and 40.0 parts by mass of tetrahydrofuran were mixed using a bead mill for 12 hours to obtain a coating liquid for a charge generating layer. The obtained coating liquid for a charge generating layer was filtered using a filter with an opening of 3 μm. After that, the obtained filtrate was applied onto the intermediate layer by a dip coating method. Subsequently, the applied filtrate was dried at 50° C. for 5 minutes. In this way, a charge generating layer (film thickness: 0.3 μm) was formed on the intermediate layer.

Next, 60.0 parts by mass of a compound represented by the following formula (HTM-1) as a hole transporting agent, 100.0 parts by mass of a polycarbonate resin (“PCZ-500” manufactured by MITSUBISHI GAS CHEMICAL COMPANY, INC., a viscosity average molecular weight of 50,000) as a binder resin, 0.05 parts by mass of silicone oil (“KF96-50cs” manufactured by Shin-Etsu Chemical Co., Ltd., silicone oil having a dimethylpolysiloxane structure) as a leveling agent, 340.0 parts by mass of tetrahydrofuran as a solvent, and 60.0 parts by mass of toluene were mixed to obtain a coating liquid for a charge transporting layer. The obtained coating liquid for a charge transporting layer was applied onto the charge generating layer by a dip coating method. Subsequently, the applied coating liquid for a charge transporting layer was dried at 120° C. for 40 minutes. In this way, a charge transporting layer (film thickness: 24.7 μm or 12.7 μm) was formed on the charge generating layer.

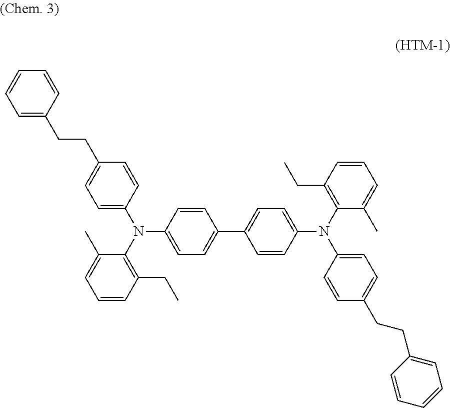 [SMILES: CCc1cccc(C)c1N(c1ccc(CCc2ccccc2)cc1)c1ccc(-c2ccc(N(c3ccc(CCc4ccccc4)cc3)c3c(C)cccc3CC)cc2)cc1]

In this way, the stacked electrophotographic photoreceptor according to Example 1, which included a photosensitive layer having a film thickness of 25 μm (0.3 μm+24.7 μm) or a photosensitive layer having a film thickness of 13 μm (0.3 μm+12.7 μm), was produced. For the evaluation of electrical properties and an environmental sensitivity difference, the stacked electrophotographic photoreceptor including a photosensitive layer having a film thickness of 25 μm was used. For the evaluation of voltage resistance, the stacked electrophotographic photoreceptor including a photosensitive layer having a film thickness of 13 μm was used.

Photoreceptors according to Example 2 to Example 9 and Comparative Example 1 to Comparative Example 9 were prepared in the same manner as that in the production of the photoreceptor according to Example 1 except that the following points were changed.

Example 2 is different from Example 1 in that the content of titanium oxide in the intermediate layer was set to 1.3 parts by mass.

Example 3 is different from Example 1 in that the content of titanium oxide in the intermediate layer was set to 1.7 parts by mass.

Example 4 is different from Example 1 in that the film thickness of the intermediate layer was set to 1.5 μm.

Example 5 is different from Example 1 in that the film thickness of the intermediate layer was set to 2.0 μm.

Example 6 is different from Example 1 in that the film thickness of the intermediate layer was set to 3.0 μm.

Example 7 is different from Example 1 in that the film thickness of the intermediate layer was set to 3.5 μm.

Example 8 is different from Example 1 in that untreated fine particles of titanium oxide (“MT-500B” manufactured by TAYCA Co., Ltd., a number average primary particle size of 35 nm) were used instead of MTX-00S.

Example 9 is different from Example 1 in that largest fine particles of titanium oxide (“MT-700BS” manufactured by TAYCA Co., Ltd., a number average primary particle size of 80 nm) that has been subjected to surface treatment with methylhydrogenpolysiloxane were used instead of MTX-00S.

Comparative Example 1 is different from Example 1 in that the content of titanium oxide in the intermediate layer was set to 1.0 part by mass.

Comparative Example 2 is different from Example 1 in that the content of titanium oxide in the intermediate layer was set to 2.0 parts by mass.

Comparative Example 3 is different from Example 1 in that fine particles of titanium oxide (“MT-05” manufactured by TAYCA Co., Ltd., a number average primary particle size of 10 nm) that has been subjected to surface treatment with alumina and silica were used instead of MTX-00S.

Comparative Example 4 is different from Example 1 in that fine particles of titanium oxide (“MT-05” manufactured by TAYCA Co., Ltd., a number average primary particle size of 10 nm) that has been subjected to surface treatment with alumina and silica were used instead of MTX-00S and the film thickness of the intermediate layer was set to 5.0 μm.

Comparative Example 5 is different from Example 1 in that fine particles of titanium oxide (“SMT-A” manufactured by TAYCA Co., Ltd., a number average primary particle size of 10 nm) that has been subjected to surface treatment with alumina, silica, and methylhydrogenpolysiloxane were used instead of MTX-00S and the film thickness of the intermediate layer was set to 0.5 μm.

Comparative Example 6 is different from Example 1 in that fine particles of titanium oxide (“SMT-A” manufactured by TAYCA Co., Ltd., a number average primary particle size of 10 nm) that has been subjected to surface treatment with alumina, silica, and methylhydrogenpolysiloxane were used instead of MTX-00S.

Comparative Example 7 is different from Example 1 in that fine particles of titanium oxide (“MT-500SA” manufactured by TAYCA Co., Ltd., a number average primary particle size of 35 nm) that has been subjected to surface treatment with alumina and silica were used instead of MTX-00S.

Comparative Example 8 is different from Example 1 in that fine particles of titanium oxide (“MT-500SAS” manufactured by TAYCA Co., Ltd., a number average primary particle size of 35 nm) that has been subjected to surface treatment with alumina, silica, and methylhydrogenpolysiloxane were used instead of MTX-00S.

Comparative Example 9 is different from Example 1 in that fine particles of zinc oxide (“MZY-303S” manufactured by TAYCA Co., Ltd., a number average primary particle size of 35 nm) that has been subjected to surface treatment with methylhydrogenpolysiloxane were used instead of MTX-00S and the content of zinc oxide (titanium oxide in Example 1) in the intermediate layer was set to 1.0 part by mass.

### (Production of Single-Layer Photoreceptor for Evaluation)

A single-layer photoreceptor for evaluation (photoreceptor according to Example 10) was produced as follows.

First, as a conductive base, a drum-shaped support that has a diameter of 30 mm and is formed of aluminum was prepared. Next, 1.5 parts by mass of titanium oxide that has been subjected to surface treatment with methylhydrogenpolysiloxane while being wet dispersed (“MTX-00S” manufactured by TAYCA Co., Ltd., a number average primary particle size of 10 nm), 1 part by mass of a polyamide resin (“Amilan (registered trademark) CM8000” manufactured by TORAY INDUSTRIES, INC., a quaternary copolymerized polyamide resin of polyamide 6, polyamide 12, polyamide 66, and polyamide 610), 10 parts by mass of methanol, 1 part by mass of butanol, and 1 part by mass of toluene were mixed using a bead mill for 5 hours to obtain a coating liquid for an intermediate layer. The obtained coating liquid for an intermediate layer was filtered using a filter with an opening of 5 μm. After that, the obtained filtrate was applied onto the surface of the conductive base by a dip coating method. Subsequently, the applied filtrate was dried at 130° C. for 30 minutes. In this way, an intermediate layer (film thickness: 2.5 μm) was formed on the conductive base.

Next, 2.85 parts by mass of a Y-type titanyl phthalocyanine as a charge generating agent, 70.0 parts by mass of the compound represented by the formula (HTM-1) as a hole transporting agent, 40.0 parts by mass of the compound represented by the following formula (ETM-1) as an electron transporting agent, 100.0 parts by mass of a polycarbonate resin (“PCZ-500” manufactured by MITSUBISHI GAS CHEMICAL COMPANY, INC., a viscosity average molecular weight of 50,000) as a binder resin, 0.02 parts by mass of silicone oil (“KF96-50cs” manufactured by Shin-Etsu Chemical Co., Ltd., silicone oil having a dimethylpolysiloxane structure) as a leveling agent, and 500.0 parts by mass of tetrahydrofuran as a solvent were mixed using a rod-shaped sonic oscillator for 20 minutes to obtain a coating liquid for a photosensitive layer. The obtained coating liquid for a photosensitive layer was filtered using a filter with an opening of 5 μm. After that, the obtained filtrate was applied onto the intermediate layer by a dip coating method. Subsequently, the applied filtrate was dried at 110° C. for 60 minutes. In this way, a photosensitive layer (film thickness: 25 μm or 13 μm) was formed on the intermediate layer.

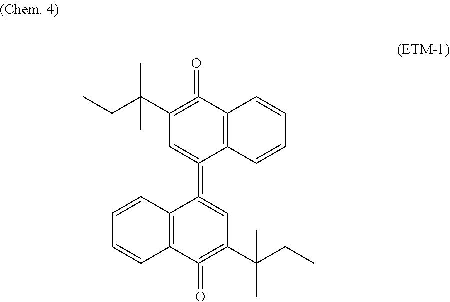

In this way, a single-layer electrophotographic photoreceptor according to Example 10, which included a photosensitive layer having a film thickness of 25 μm or a photosensitive layer having a film thickness of 13 μm, was produced. For the evaluation of electrical properties and an environmental sensitivity difference, the single-layer electrophotographic photoreceptor including a photosensitive layer having a film thickness of 25 μm was used. For the evaluation of voltage resistance, a single-layer electrophotographic photoreceptor including a photosensitive layer having a film thickness of 13 μm was used.

### (Evaluation of Electrical Properties of Stacked Photoreceptor)

For the evaluation of the electrical properties of the produced stacked photoreceptor, the post-exposure potential of the photoreceptor was measured using a drum sensitivity tester (manufactured by GENTEC) in an environment of a temperature of 23° C. and a relative humidity of 50% RH. First, the surface of the photoreceptor was charged such that the surface potential of the photoreceptor became-600 V. After that, monochromatic light (exposure wavelength: 780 nm) was applied to the surface of the photoreceptor at an exposure amount of 0.87 μJ/cm² for exposure. The surface potential of the exposure region of the photoreceptor 50 ms after exposure was measured. The measured surface potential was used as the post-exposure potential.

### (Evaluation of Electrical Properties of Single-Layer Photoreceptor)

For the evaluation of the electrical properties of the produced single-layer photoreceptor, the post-exposure potential of the photoreceptor was measured using a drum sensitivity tester (manufactured by GENTEC) in an environment of a temperature of 23° C. and a relative humidity of 50% RH. First, the surface of the photoreceptor was charged such that the surface potential of the photoreceptor became +600 V. After that, monochromatic light (exposure wavelength: 780 nm) was applied to the surface of the photoreceptor at an exposure amount of 0.87 μJ/cm² for exposure. The surface potential of the exposure region of the photoreceptor 50 ms after exposure was measured. The measured surface potential was used as the post-exposure potential.

Note that the smaller the value of the post-exposure potential (provided it is 0 V or more), the higher the sensitivity of the photoreceptor. The sensitivity of each photoreceptor was evaluated in accordance with the following criteria.
Evaluation A: the absolute value of the post-exposure potential was 130 V or less.
Evaluation B: the absolute value of the post-exposure potential exceeded 130 V.

### (Evaluation of Environmental Sensitivity Difference of Stacked Photoreceptor)

For the evaluation of the environmental sensitivity difference of the produced stacked photoreceptor, the post-exposure potential of the photoreceptor was measured as follows using a drum sensitivity tester (manufactured by GENTEC) in an environment of a temperature of 10° C. and a relative humidity of 15% RH. First, the surface of the photoreceptor was charged such that the surface potential of the photoreceptor became-600 V. After that, monochromatic light (exposure wavelength: 780 nm) was applied to the surface of the photoreceptor at an exposure amount of 0.15 μJ/cm² for exposure. The surface potential of the exposure region of the photoreceptor 50 ms after exposure was measured. The measured surface potential was used as the post-exposure potential.

The measurement environment was changed to an environment of a temperature of 32° C. and a relative humidity of 80% RH, and the post-exposure potential of the photoreceptor was measured in the same manner as above. Of the post-exposure potentials obtained in this way, one post-exposure potential is subtracted from the other post-exposure potential and the absolute value of the obtained difference was used as an environmental sensitivity difference.

### (Evaluation of Environmental Sensitivity Difference of Single-Layer Photoreceptor)

For the evaluation of the environmental sensitivity difference of the produced single-layer photoreceptor, the post-exposure potential of the photoreceptor was measured as follows using a drum sensitivity tester (manufactured by GENTEC) in an environment of a temperature of 10° C. and a relative humidity of 15% RH. First, the surface of the photoreceptor was charged such that the surface potential of the photoreceptor became +600 V. After that, monochromatic light (exposure wavelength: 780 nm) was applied to the surface of the photoreceptor at an exposure amount of 0.15 μJ/cm² for exposure. The surface potential of the exposure region of the photoreceptor 50 ms after exposure was measured. The measured surface potential was used as the post-exposure potential.

The measurement environment was changed to an environment of a temperature of 32° C. and a relative humidity of 80% RH, and the post-exposure potential of the photoreceptor was measured in the same manner as above. Of the post-exposure potentials obtained in this way, one post-exposure potential is subtracted from the other post-exposure potential and the absolute value of the obtained difference was used as an environmental sensitivity difference.

The environmental sensitivity difference of each photoreceptor was evaluated in accordance with the following criteria.
Evaluation A: the environmental sensitivity difference was 60 V or less.
Evaluation B: the environmental sensitivity difference exceeded 60 V.

### (Evaluation of Voltage Resistance of Stacked Photoreceptor)

For the evaluation of the voltage resistance of the produced stacked photoreceptor, the voltage (unit: +kV) when leakage occurred in the photoreceptor was measured as follows using a modified unit obtained by connecting a high-voltage power source to the charging roller of the process unit of a multifunction device (“Taskalfa 356ci” manufactured by KYOCERA Document Solutions Inc.). First, the photoreceptor was set in the process unit. In a dark place, a voltage was applied to the charging roller for 3 minutes in an environment of a temperature of 23° C. and a relative humidity of 50% RH with a starting voltage of 2.0 kV, and then, a negative voltage was applied at a voltage reduction rate of −0.2 kV/3 minutes. Then, the voltage when leakage occurred in the photoreceptor was measured. The position of the measurement surface was shifted each time a measurement was taken, and the voltage was measured a total of three times. The absolute value of the average value of the values obtained by the three measurements was used as a measurement value of voltage resistance. The measurement value is shown in the column of the “voltage resistance” in Table 1. The higher the measurement value, the higher the voltage resistance of the photoreceptor. Note that in the measurement of voltage resistance, elimination of static electricity was not performed.

### (Evaluation of Voltage Resistance of Single-Layer Photoreceptor)

For the evaluation of the voltage resistance of the produced single-layer photoreceptor, the voltage (unit: +kV) when leakage occurred in the photoreceptor was measured as follows using a modified unit obtained by connecting a high-voltage power source to the charging roller of the process unit of a multifunction device (“Taskalfa 356ci” manufactured by KYOCERA Document Solutions Inc.). First, the photoreceptor was set in the process unit. In a dark place, a voltage was applied to the charging roller for 3 minutes in an environment of a temperature of 23° C. and a relative humidity of 50% RH with a starting voltage of 2.0 kV, and then, a positive voltage was applied at a voltage rise rate of +0.2 kV/3 minutes. Then, the voltage when leakage occurred in the photoreceptor was measured. The position of the measurement surface was shifted each time a measurement was taken, and the voltage was measured a total of three times. The absolute value of the average value of the values obtained by the three measurements was used as a measurement value of voltage resistance. The measurement value is shown in the column of the “voltage resistance” in Table 1. The higher the measurement value, the higher the voltage resistance of the photoreceptor. Note that in the measurement of voltage resistance, elimination of static electricity was not performed.

The voltage resistance of each photoreceptor was evaluated in accordance with the following criteria.
Evaluation A: the measurement value was 2.6 k V or more.
Evaluation B: the measurement values was less than 2.6 k V.

TABLE 1

| | | Metal oxide | | | Resin | |
|---|---|---|---|---|---|---|
| | | Type | Surface treatment | Parts by mass | Type | Parts by mass |
| Example | 1 | MTX-00S | Methylhydrogenpolysiloxane | 1.5 | CM8000 | 1.0 |
| | 2 | MTX-00S | Methylhydrogenpolysiloxane | 1.3 | CM8000 | 1.0 |
| | 3 | MTX-00S | Methylhydrogenpolysiloxane | 1.7 | CM8000 | 1.0 |
| | 4 | MTX-00S | Methylhydrogenpolysiloxane | 1.5 | CM8000 | 1.0 |
| | 5 | MTX-00S | Methylhydrogenpolysiloxane | 1.5 | CM8000 | 1.0 |
| | 6 | MTX-00S | Methylhydrogenpolysiloxane | 1.5 | CM8000 | 1.0 |
| | 7 | MTX-00S | Methylhydrogenpolysiloxane | 1.5 | CM8000 | 1.0 |
| | 8 | MT-500B | None | 1.5 | CM8000 | 1.0 |
| | 9 | MT-700BS | Methylhydrogenpolysiloxane | 1.5 | CM8000 | 1.0 |
| | 10 | MTX-00S | Methylhydrogenpolysiloxane | 1.5 | CM8000 | 1.0 |
| Comparative | 1 | MTX-00S | Methylhydrogenpolysiloxane | 1.0 | CM8000 | 1.0 |
| Example | 2 | MTX-00S | Methylhydrogenpolysiloxane | 2.0 | CM8000 | 1.0 |
| | 3 | MT-05 | Al, Si | 1.5 | CM8000 | 1.0 |
| | 4 | MT-05 | Al, Si | 1.5 | CM8000 | 1.0 |
| | 5 | SMT-A | Al, Si, methylhydrogenpolysiloxane | 1.5 | CM8000 | 1.0 |
| | 6 | SMT-A | Al, Si, methylhydrogenpolysiloxane | 1.5 | CM8000 | 1.0 |
| | 7 | MT-500SA | Al, Si | 1.5 | CM8000 | 1.0 |
| | 8 | MT-500SAS | Al, Si, methylhydrogenpolysiloxane | 1.5 | CM8000 | 1.0 |
| | 9 | MZY-303S | Methylhydrogenpolysiloxane | 1.0 | CM8000 | 1.0 |

| | | | Electrical | | Environmental | | Voltage | |
|---|---|---|---|---|---|---|---|---|
| | | Film | properties | | sensitivity difference | | resistance | |
| | | thickness | Sensitivity | | Sensitivity | | Leakage | |
| | | (μm) | (V) | Evaluation | difference (V) | Evaluation | voltage (kV) | Evaluation |
| Example | 1 | 2.5 | 95 | A | 48 | A | 2.9 | A |
| | 2 | 2.5 | 100 | A | 50 | A | 3.0 | A |
| | 3 | 2.5 | 92 | A | 48 | A | 2.9 | A |
| | 4 | 1.5 | 94 | A | 48 | A | 2.8 | A |
| | 5 | 2.0 | 94 | A | 48 | A | 2.9 | A |
| | 6 | 3.0 | 94 | A | 48 | A | 2.9 | A |
| | 7 | 3.5 | 94 | A | 49 | A | 2.9 | A |
| | 8 | 2.5 | 106 | A | 53 | A | 3.1 | A |
| | 9 | 2.5 | 120 | A | 51 | A | 3.3 | A |
| | 10 | 2.5 | 89 | A | 44 | A | 2.8 | A |
| Comparative | 1 | 2.5 | 135 | B | 67 | B | 3.7 | A |
| Example | 2 | 2.5 | 90 | A | 47 | A | 2.4 | B |
| | 3 | 2.5 | 92 | A | 49 | A | 2.3 | B |
| | 4 | 5.0 | 93 | A | 51 | A | 2.4 | B |
| | 5 | 0.5 | 116 | A | 64 | B | 2.2 | B |
| | 6 | 2.5 | 130 | A | 72 | B | 2.7 | A |
| | 7 | 2.5 | 110 | A | 60 | A | 2.4 | B |
| | 8 | 2.5 | 120 | A | 68 | B | 2.5 | B |
| | 9 | 2.5 | 155 | B | 82 | B | 2.7 | A |

### Evaluation of Examples and Comparative Examples

As shown in Table 1, all of the photoreceptors according to Example 1 to Example 10 had favorable electrical properties, high voltage resistance, and a small environmental sensitivity difference. This is presumably because electrical properties can be improved, electric resistance can be increased, and environmental changes can be suppressed by causing the intermediate layer to include appropriate titanium oxide and an appropriate resin at an appropriate ratio.

As shown in Table 1, the photoreceptor according to Comparative Example 1 had high voltage resistance but had a large environmental sensitivity difference. This is presumably because the content of titanium oxide is 1.0 part by mass, which is less than 1.3 parts by mass, with respect to 1.0 part by mass of the polyamide resin, resulting in an insufficient effect of the reducing the environmental sensitivity difference by titanium oxide.

As shown in Table 1, the photoreceptor according to Comparative Example 2 had a small environmental sensitivity difference but had low voltage resistance. This is presumably because the content of titanium oxide is 2.0 parts by mass, which exceeds 1.7 parts by mass, with respect to 1.0 part by mass of the polyamide resin, resulting in an insufficient effect of increasing electric resistance by reducing the amount of titanium oxide.

As shown in Table 1, the photoreceptor according to Comparative Example 3 had a small environmental sensitivity difference but had low voltage resistance. This is presumably because titanium oxide has been subjected to surface treatment with an inorganic material such as alumina and silica, resulting in reduction of electric resistance.

As shown in Table 1, the photoreceptor according to Comparative Example 4 had a small environmental sensitivity difference but had low voltage resistance. This is presumably because titanium oxide has been subjected to surface treatment with an inorganic material such as alumina and silica, resulting in reduction of electric resistance.

As shown in Table 1, the photoreceptor according to Comparative Example 5 had a small environmental sensitivity difference and low voltage resistance. This is presumably because titanium oxide has been subjected to surface treatment with an inorganic material such as alumina and silica, making it susceptible to environmental changes, and the film thickness of the intermediate layer is too small.

As shown in Table 1, the photoreceptor according to Comparative Example 6 had high voltage resistance but an environmental sensitivity difference. This is presumably because titanium oxide has been subjected to surface treatment with an inorganic material such as alumina and silica, making it susceptible to environmental changes.

As shown in Table 1, the photoreceptor according to Comparative Example 7 had a small environmental sensitivity difference but had low voltage resistance. This is presumably because titanium oxide has been subjected to surface treatment with an inorganic material such as alumina and silica, resulting in reduction of electric resistance.

As shown in Table 1, the photoreceptor according to Comparative Example 8 had a small environmental sensitivity difference and low voltage resistance. This is presumably because titanium oxide has been subjected to surface treatment with an inorganic material such as alumina and silica, making it susceptible to environmental changes, and electric resistance was reduced.

As shown in Table 1, the photoreceptor according to Comparative Example 9 had high voltage resistance but had a large environmental sensitivity difference. This is presumably because zinc oxide was used instead of titanium oxide, resulting in an insufficient effect of the reducing the environmental sensitivity difference.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photoreceptor, comprising:
a conductive base;
an intermediate layer provided on the conductive base; and
a photosensitive layer provided on the intermediate layer,
the intermediate layer including titanium oxide and an intermediate layer resin, the titanium oxide having been subjected to no surface treatment with an inorganic material,
a content of the titanium oxide being 1.3 parts by mass or more and 1.7 parts by mass or less with respect to 1.0 part by mass of the intermediate layer resin.

2. The electrophotographic photoreceptor according to claim 1, wherein
the intermediate layer resin is a polyamide resin.

3. The electrophotographic photoreceptor according to claim 1, wherein
the intermediate layer has a film thickness of 1.5 μm or more and 3.5 μm or less.

4. The electrophotographic photoreceptor according to claim 1, wherein
a content of the titanium oxide is 1.4 parts by mass or more and 1.6 parts by mass or less with respect to 1.0 part by mass of the intermediate layer resin.

5. A process cartridge, comprising:
at least one selected from the group consisting of a charging device, an exposure device, a development device, a transfer device, a cleaning member, a rubbing roller, and a static elimination device; and
the electrophotographic photoreceptor according to claim 1.

6. An image forming apparatus, comprising:
an image carrier;
a charging device that charges a surface of the image carrier;
an exposure device that exposes the charged surface of the image carrier to form an electrostatic latent image on the surface of the image carrier;
a development device that supplies a toner to the surface of the image carrier to develop the electrostatic latent image as a toner image;
a transfer device that transfers the toner image from the image carrier to a to-be-transferred body;
a cleaning member that cleans the surface of the image carrier; and
a static elimination device that eliminates static electricity on the surface of the image carrier,
the image carrier being the electrophotographic photoreceptor according to claim 1.

7. The image forming apparatus according to claim 6, wherein
the charging device is a charging roller.

8. The image forming apparatus according to claim 6, wherein
the development device adopts a two-component development method.
